(19) United States
(12) Patent Application Publication
(10) Pub. No.: US 2004/0061721 A1
(43) Pub. Date: Apr. 1, 2004

(54) Interactive digital environment structured in the format of a paper publication

(76) Inventor: Luca Bosurgi, London (GB)

Correspondence Address: Rashida A. Karmali, Ph.D, 10th Floor, 99 Wall Street, New York, NY, 10005, US

(21) Appl. No.: 10/664,474

(22) Filed: Sep. 18, 2003

Related U.S. Application Data
(63) Continuation-in-part of application No. 09/823,358, filed on Mar. 30, 2001.

(51) Int. Cl. G09G 5/00

(52) U.S. Cl. 345/764

(57) ABSTRACT

The present invention relates to software tools for facilitating the management and navigation of World Wide Web sites, interactive digital environments, and other types of data systems by structuring them like a paper publication instead of using hyperlinks to facilitate user navigation. The present invention provides a system in which each screen represents a multiple page spread, and each page allows a combination of text, motion, image, or video in a multimedia format.

### CROSS-REFERENCE TO RELATED APPLICATION

This Application is a Continuation-in-Part of co-pending application ‘INTERACTIVE DIGITAL ENVIRONMENT STRUCTURED IN THE FORMAT OF A PAPER PUBLICATION, Ser. No. 09/823,358, filed on Mar. 30, 2001, said application is incorporated herein by reference.

### BACKROUND OF THE INVENTION

1. Field of Invention

The present invention relates to software tools for facilitating the management and navigation of World Wide Web sites, interactive digital environments, and other types of data systems by structuring their appearance so that they appear like a paper publication instead of using hyperlinks to facilitate user navigation. Navigation of the site also bears striking similarities to paper publications.

2. Description of Related Art

The task of managing Website content while maintaining website effectiveness and lure are becoming increasingly difficult as Internet and intranet application continue to become increasingly complex. Business managers and webmasters are faced with a variety of tasks, including for example, the identification and repair of broken links, the monitoring of large volumes of changing website content and management of congested links. These problems, when combined with user's propensity to leave pages that are not immediately available have become troublesome. As e-commerce becomes an increasingly important facet of mainstream business the importance of WebPages continues to rise. This importance is exponentially greater for companies who rely on the web for their primary source of income.

The present invention addresses these and other limitations in existing websites and related technologies, by providing an environment that is appealing to individuals who are not yet accustomed to relying on the web as a normal source of information and entertainment as well as individuals who demand the latest technology.

Varying formats exist for the display of books and magazines on electronic mediums. Several shortcomings exist within the present state of the field. Those few publications that manage to successfully publish material in a manner that is a believable representation of a book, magazine, or other publication tend to fail to take full advantage of all of the features which are available within electronic mediums. The below referenced prior art applications and patent fail to posses, either alone or in combination, the features of the named Invention.

United Stated Application Number 2001/0050658-A1 by Adams teaches a ‘System and Method for Displaying Online Content in Opposing-Page Magazine Format.’ Adams however, fails to utilize the marketing potential of the electronic medium. In addition, the presence and use of a spine is not present in Adams, or for that matter anywhere in the prior art, in a manner comparable to that used by the Invention.

United States Patent Application Number 2002/0083101-A1 by Card et al. teaches an indexing method for the electronic representation of books, wherein a DOI (degree of interest) algorithm determines which other types of materials might be of use/interest to the user.

U.S. Pat. No. 6,411,811-B1 by Sawada et al. teaches a method of electronic display of a book, wherein turning pages appear to be flexible, so that the process of page turning appears more realistic. However, a major shortcoming exists in the design of Sawada. In order to accommodate the visual of a turning page all data must be stored as images. As such, a content provider loses the flexibility that exists when his page relies exclusively on text images. The flaw of depending exclusively on image data is not present in the Invention; it is instead replaced by text, image, audio, and multimedia files. Also, the below described functioning of the spine is not utilized by Sawada.

### SUMMARY OF THE INVENTION

In accordance with the present invention, an innovative system is provided which includes a variety of features for facilitating the management and use of web sites and other interactive digital environments. In the preferred embodiment, a web site is built like a paper publication such that, even though a web site, it may be read with the ease associated with reading a magazine. In other words, the present invention provides a system in which each screen represents a double page spread and the user is able to turn the pages, i.e., flick, in the same way as with a traditional paper publication. Pages are flipped when the user clicks on icons in the corners of the display; said icons appear like partially folded pages, their appearance is such that it makes obvious their function.

The present invention provides a system wherein each page allows a combination of text, sound, motion, images or video (hereinafter collectively “features”) in a multimedia format, thereby upgrading the images and text to an entertaining and interactive experience for the user. The invention places as much importance on multimedia files, including but not limited to, .jpegs, .mpegs, .mp3s or .vmvs as it does on plain text. The result is a dynamic environment, one unattainable by hard copy magazines and previously unattained by e-zines.

The present invention further provides a system having a format of a paper publication, a format heretofore not present in the manner taught by the invention. Such a format provides the user with the familiarity of a paper publication, making it an intuitive format that even the least computer savvy individuals are able to easily navigate. The aesthetic similarities between paper publications and the e-zine described in the preferred embodiment make the Invention appealing to individuals who are still not yet comfortable with relying on electronic means as a primary source of information, while still appealing to those who demand the latest in audiovisual technology.

The invention further provides advertisers with an innovative, authentic, entertaining and unobtrusive medium. Advertisements appear in a manner similar to that used by paper publications, with advantages that are heretofore not present in the art. Advertisements placed in a non-invasive manner in the layout of the e-zine appear more natural and draw more attention from the user. Users have become immune to pop-up ads, instinctively closing them as soon as they open without giving any consideration to their content. Click through rates for pop-up ads are routinely below one in a thousand. The ad placement in the preferred embodiment is such that they appear as appropriate facets of the e-zine. Ads may be incorporated as one of the multiple aspects of a two-page spread or they may be the sole content. The latter option is an alternative wherein the advertisement attracts a substantial amount of attention, without pestering users as a pop-up ad would.

The advertisement format provided by the preferred embodiment allows companies to brand strategy as they see fit. The self-contained advertising environment is such that it allows companies to create entertaining advertisements, comprised of rich media content. As the companies rent the space they are free to change their advertisements when, and as, they see fit as the invention provides a self-contained environment where advertisers and brands may develop their exclusive, spacious environment and strategy. The digital environment's spacious nature further allows companies to include substantially more content than they possibly could in the limited physical environment offered in most magazines.

A further advantage of the ads in the preferred embodiment is that they allow for immediate purchase of advertised products or services. This is an advantage that is impossible with paper publications and not properly utilized by the inventions described in the art. Whereas paper products may provide a means by which to contact a distributor, i.e., a telephone number or website, the advertisements in the preferred embodiment allow a user to link directly to the advertiser.

One particular embodiment of the present invention is called “F magazine”. F magazine is a user-friendly system, having a full table of contents page similar and capable of having an index. This page allows the user to navigate in a non-linear movement through the content. The invention thus provides an easy-to-use navigation system and includes numbered pages, thereby representing the next step toward simplicity and providing an instinctive and efficient approach to the net and its associated information and education portals.

An innovation of the present invention is the use of an electronic bookmark (hereinafter “e-mark”). The e-mark is located to the right of the second fold in the preferred embodiment. When the user wishes to mark a page s/he simply clicks on the e-mark and drags onto the page. The user can then return to the page by clicking on the protruding aspect of the e-mark. Use of the e-mark is both intuitive and efficient.

An advantage over paper publications and other e-zines is the presence of a ‘spine’. A spine traditionally refers to the place where a magazine is bound; when open a magazine's spine is the crease that separates the two pages. The spine in the present invention serves a purpose, whereas in previous e-zines it merely operated as a feature designed to further the aesthetic similarities between paper magazines and e-zines. The spine allows the user to link instantly to several features, including but not limited to, the table of contents, the jukebox, or navigation tips.

In the preferred embodiment the spine on the cover page is central, that is, the spine is located in between the first and second fold on the cover page. Once the user begins to browse the e-zine the spine's location changes, so that it is positioned to the left of both the first and second fold. The location previously occupied by the spine may or may not contain a ‘crease’, said ‘crease’ serving the sole purpose of aesthetic presentation. When desired the ‘crease’ can be removed so that both pages appear as one continuous entity. In other words, the line that stimulates the crease of the bind is technically totally separate from the functional spine, and is purely cosmetic, that is, it can be removed in some designs.

The spine, when coupled with the ability to ‘flip pages’, further serves the purpose of improving navigation. Traditional e-zines use hyperlinks and scrolling to control navigation. The use of hyperlink removes any sense of sequence that is associated with traditional paper publications. The spine contains links to certain areas of the e-zine in the preferred embodiment. The combination of the spine and the ability to flip pages allows users to navigate the e-zine in the same manner they would employ when navigating a paper publication; users may either go through sequentially or jump directly to specific features.

The enriched media environment of the e-zine is further enhanced through the presence of a virtual jukebox. The jukebox plays streaming music, which can be listened to while browsing the magazine. The music is not available in a downloadable form. Playing music in streaming form places the e-zine in a position of financial advantage. Having downloadable music available on one's site brings with it the disadvantage of licensing fees. Companies that provide downloadable copyrighted music without approval are faced with the constant threat of litigation. Playing streaming media is similar to playing a song on a radio, except the cost to the provider is substantially lower.

The present invention further includes an application of newspaper or newsletter publication format in e-ecommerce (entertainment e-commerce). Traditional e-commerce sites generate graphical maps, which tend to be difficult to navigate and fail to convey much of the information needed by the Web user. The present invention integrates into its editorial the functionality of interactive mail order. This feature gives the user the experience of a beautiful magazine with an instant and simple facility to buy featured products. The system places the product throughout the content and creates the right environment to stimulate the desire and imagination of the customer.

The present invention provides a method by which F magazine acts as an intermediary, collecting orders for reputable e-commerce companies and for brands organized to sell online. As briefly described above, products advertised have at least a tangential relationship to the features of the e-zine. An obvious example of this function is when an advertisement is in juxtaposition to the exact article of clothing worn or song played. However, this is not necessarily the case. A feature on a musician may include an article and accompanying multimedia or music file.

While an advertisement accompanying an article may market the musician's art it may also market related items, such as, clothing related to the genre in which the musician performs, clothing bearing the name or logo of the musician's company i.e., RocaWear, a clothing line sold and distributed by Rockafellar Records, Inc. or other products or merchandise related in some tangential fashion to the artist. A further example would be accessories commonly associated with the style of music, for example, bright plastic jewelry is common among individuals interested in particular styles of dance music.

Each page of the e-zine is a flash movie, built with Macromedia Flash. Individual pages can be hosted in the e-zones server or a foreign server. It is this capability that allows advertisers, or contributors, to have such extensive control over content. Flash provides for large formats, formats heretofore not seen in this field.

The various features of the invention will now be described in greater detail with reference to the drawings of a preferred software package for F magazine, its screen displays and various related components.

### DETAILED DESCRIPTION OF THE PREFERRED EMBODIMENT

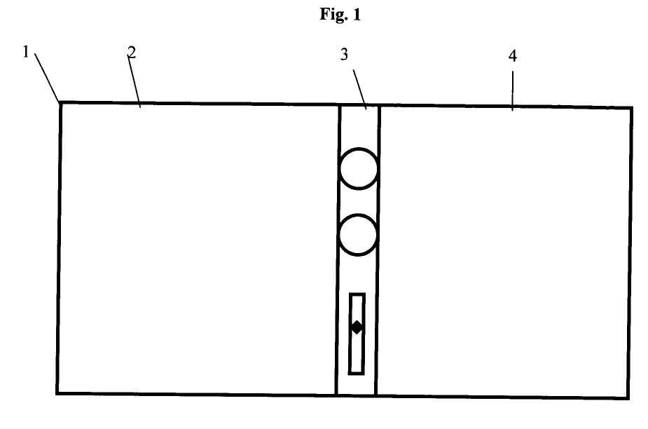

FIG. 1 shows a representation of an Internet accessible e-zinel, where the sole function of the spine is to serve as a means to open the table of contents. Comprising essentially of three sections, a first fold 2, a spine 3, and a second fold 4. This drawing shows a format that the preferred embodiment, F-Magazine can occupy. F Magazine contains multiple features as described in ‘Summary of the Invention’, in addition to a spine that serves multiple purposes, including but not limited to, a volume control means, a means of connection to a jukebox and a means of connection to the table of content.

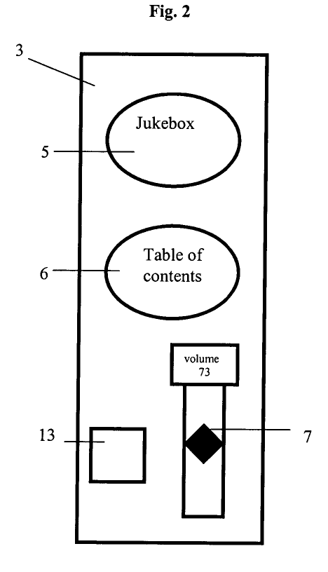

FIG. 2 shows a representation of the spine 3 in isolation. Certain features of the spine include, but are not limited to, a means of connection to the jukebox 5, a means of connection to the table of content 6, a volume control means 7, a means by which to pause or start the streaming media 13. The spine 3 is a feature previously unused in the prior art. In previous e-zines the spine served merely as an aesthetic feature that increased the likeness between electronic publications and paper publications, the use of and features of the spine is unique to the present invention.

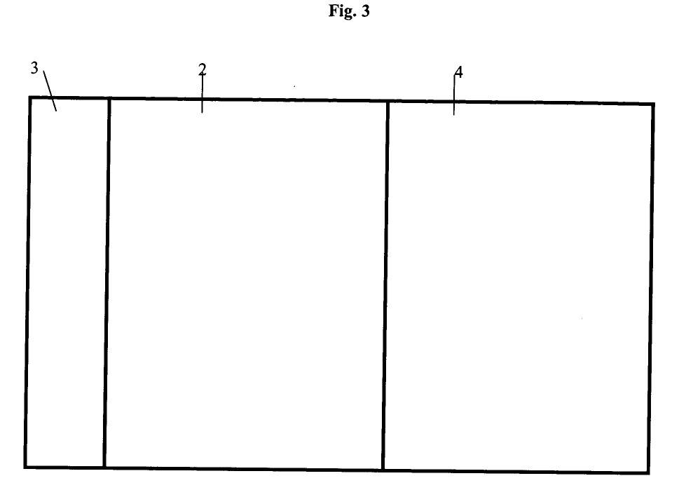

FIG. 3 shows a representation of the preferred embodiment, wherein the spine 3 is located to the left of both the first fold 2 and the second fold 4.

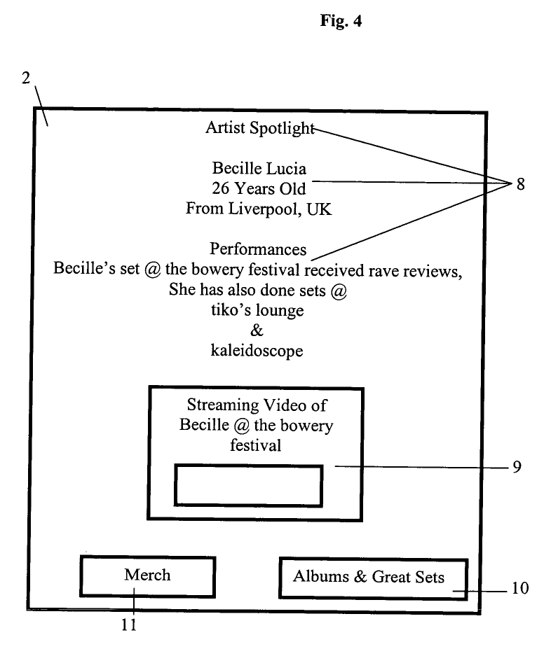

FIG. 4 shows a representation of the first fold 2, wherein its contents 8 include biographical information about an artist. The fold further contains a video clip of the artist performing live 9 and a means to buy her previous albums 10, and other related merchandise 11. The connection means titled “Merch” would be operatively connected so that a distributor would have the ability to sell online. As described in ‘Summary of the Invention’ this merchandise could be directly connected to the artist, or it could have a mere tangential connection, i.e., a type of clothing popular among fans of the artist.

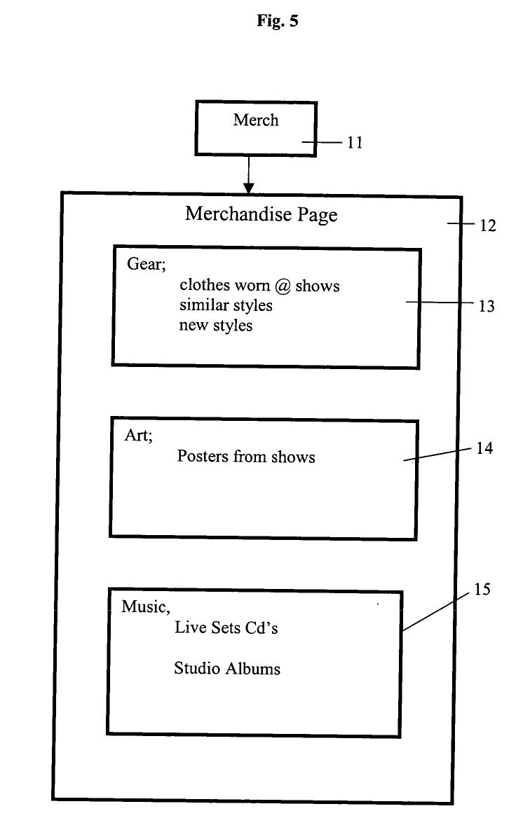

FIG. 5 shows a merchandising page 12, which is reached through the merch link 11. The merchandising page 12 in this embodiment is capable of selling Clothing and apparel 13, art related to the artist or musician 14, and music 15.

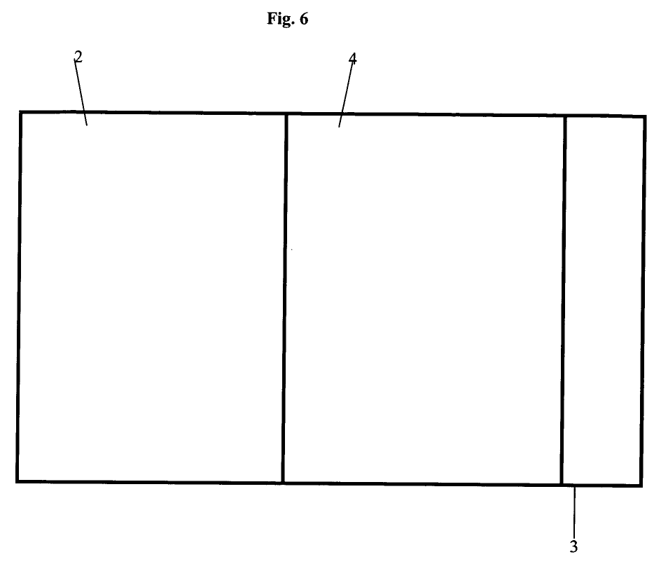

FIG. 6 shows a representation of the embodiment, wherein the spine 3 is located at the right of both the first fold 2 and second fold 4.

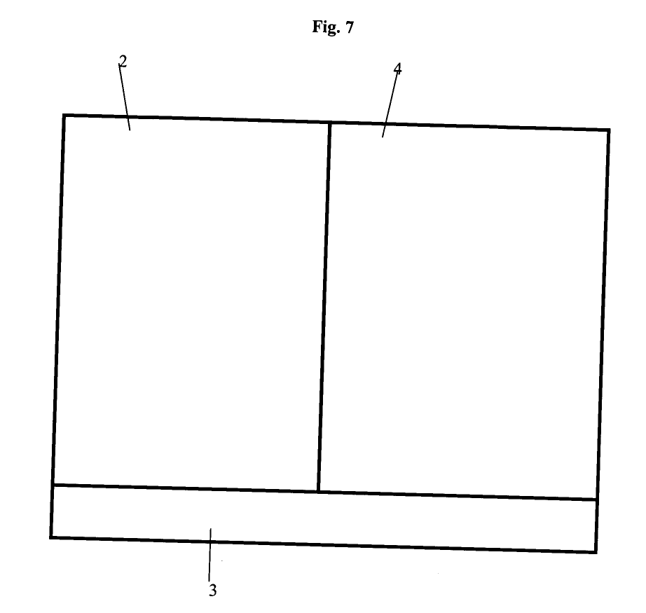

FIG. 7 shows a representation of the embodiment, wherein the spine 3 is located below both the first fold 2 and the second fold 4.

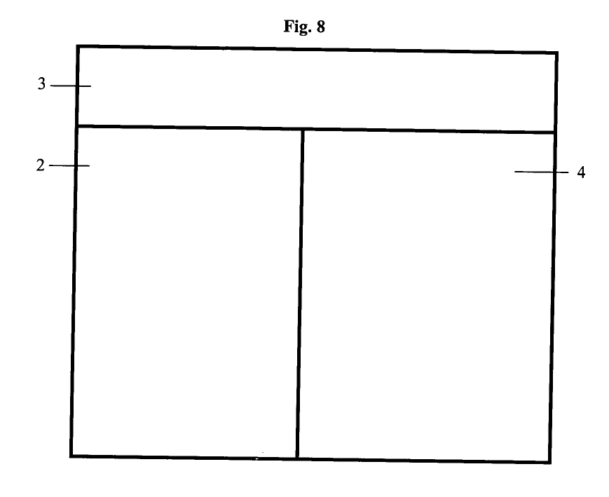

FIG. 8 shows a representation of the embodiment, wherein the spine 3 is located above both the first fold 2 and second fold 4.

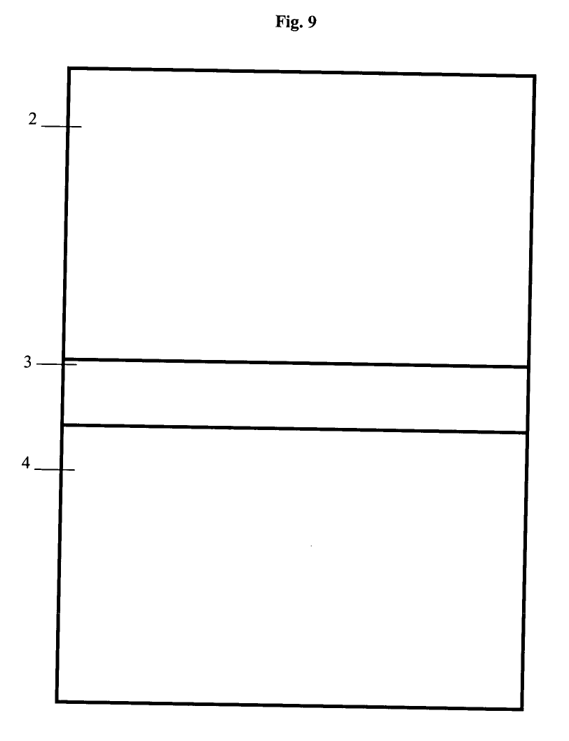

FIG. 9 shows a representation of the embodiment, wherein the e-zine is oriented so that the spine 3 is horizontal and located between the first fold 2 and second fold 4.

The embodiments described in FIGS. 5 to 8 can also be presented in the form of an entertaining or transactional based newsletter or newspaper, whose purpose is to inform or market a product. In such an environment opportunities to purchase goods or services is provided on numerous occasions throughout the newsletter or newspaper.

Countless variations on these designs should be obvious from the above disclosure and the drawings. The drawings should be viewed as exemplifications of a single embodiment of the same Invention and should not be interpreted to limit the scope of the Invention in any manner. While the above description contains many specifics, these specifics should not be construed as limitations on the scope of the invention, but merely as exemplification of preferred embodiments thereof. Those skilled in the art will envision many other possible variations that are within the scope and spirit of the invention as defined by the claims appended hereto.

What is claimed is:

1. A system for an interactive digital environment, structured in the format of a paper publication, said system comprising:
an interactive component including a plurality of multimedia feature pages,
a navigational component which has an executable code for flipping the pages over a network connection, and an application which allows a user to navigate to any page instinctively, and
a spine, which is located in between the first and second folds on the cover page and whose location becomes to the left of said first fold and said second fold after said cover page, whose functions include, but are not limited to, a navigations means or volume control means.

2. The system according to claim 1, further comprising an e-commerce component, said component facilitating products placement, illustration and purchase of products displayed over the network connection.

3. The system according to claim 2, further comprising an electronic bookmarks,

4. The system according to claim 2, further comprising a third fold.

5. The system according to claim 3, further comprising a fourth fold.
